(19) United States
(12) Patent Application Publication
(10) Pub. No.: US 2017/0217281 A1
(43) Pub. Date: Aug. 3, 2017

(54) DEVICE FOR FILLING VEHICLE AIR CONDITIONING SYSTEMS WITH COOLANT R744

(71) Applicant: DÜRR SOMAC GmbH, Stollberg (DE)

(72) Inventor: Thomas ACHATZ, Niederdorf (DE)

(73) Assignee: DÜRR SOMAC GmbH, Stollberg (DE)

(21) Appl. No.: 15/501,315

(22) PCT Filed: Jul. 30, 2015
(86) PCT No.: PCT/DE2015/000394

§ 371 Date: Feb. 2, 2017

(30) Foreign Application Priority Data
Aug. 8, 2014 (DE) 10 2014 011 836.3

(51) Int. Cl. B60H 1/00

(52) U.S. Cl. CPC B60H 1/00585

(57) ABSTRACT

The invention relates to a device for filling vehicle air conditioning systems with refrigerant R744 in such a manner that it allows the calculation of mass deviations in line sections during filling with the refrigerant R744. An adapter hose assembly is configured such that it is segmented, wherein segmentation takes place by inserting several pairs of respectively separate temperature and pressure sensors for determining the respective density of the refrigerant in the adapter hose assembly. The device comprises a mass calculator for controlling the filling valve in accordance with a central correction calculation based on different density deviations determined using the pairs of respectively separate temperature and pressure sensors and also using the parameters of the mass measurement provided by the mass flow meter.

### CROSS-REFERENCE TO RELATED APPLICATIONS

This application is a 371 U.S. National Stage of International Application No. PCT/DE2015/000394, filed Jul. 30, 2015. This application claims the benefit of and priority to German Patent Application No. 102014011836.3, filed Aug. 8, 2014. The disclosures of the above applications are incorporated herein by reference.

### FIELD

The invention relates to a device for filling vehicle air conditioning systems with refrigerant R744.

### BACKGROUND

Based on legal requirements, vehicle air conditioning systems increasingly use refrigerants that meet environmentally friendly requirements. This includes CO2, which as a refrigerant is named R744.

The manufacturers of air conditioning systems determine the mass of refrigerant to fill the respective air conditioning system. Compliance with the required narrow tolerances is of great significance to prevent impairment of the cooling capacity and damage to the air conditioning system due to a non-conforming fill. The properties of refrigerants are described in so-called enthalpy diagrams which show the connections of pressure, temperature, density, and phase states.

Due to its properties, the refrigerant R744 passes through various physical states in the typical temperature range that prevails at European production sites. Working pressure and density are temperature dependent.

FIG. 1 shows the structure of a typical filling section for refrigerant R744. Accordingly, a filling section known from prior art substantially consists of a hydraulic cabinet (1) with pumps, lines, and storage tanks, a mass measuring system (2), an adapter hose assembly (3), and an adapter (4) with a filling valve (8).

The main disadvantage of such an arrangement for filling the refrigerant R744 into a system is that any change in temperature or pressure, regardless of its origin (local line arrangement, relief, counterpressure of the system to be filled, etc.) will change the density of the refrigerant. Thus, the mass flow measured at the beginning of the line does not match the mass flow actually filled into the air conditioning system.

According to EP 2 762 804 A1, this problem can mainly be overcome by inserting a temperature and pressure sensor (5a, 5b) at the beginning and end of the adapter hose assembly (3) that acts as the filling section. Since it is now possible to determine a potential temperature and pressure drop between the adaptation point and the mass measuring system, a suitable control system (7) can perform a calculation correction of the mass flow determined by the mass measuring system using the enthalpy diagram. The principle of such an arrangement can be seen in FIG. 2.

The disadvantage of such a design is that a potential technical segmentation of the adapter hose assembly is not taken into account and that measuring points and calculation do not form a functional unit that meets the requirements with respect to different hose segments. Adapter hose assemblies are often conducted through handling systems, an automatic hose retractor and hose storage system across different temperature zones or comprise coupling sections with changes in cross section and other specific design elements.

### SUMMARY

It is the purpose of the present invention to provide a technical solution for filling vehicle air conditioning systems which allows the calculation of mass deviations in line sections while filling a system with the refrigerant R744.

The invention relates to a device for filling vehicle air conditioning systems with refrigerant R744. The device comprises a filling system with pumps, lines, and storage tanks, an adapter hose assembly as the filling section, an adapter with a filling valve and a mass measuring system at the beginning of the filling section, wherein one temperature and pressure sensor respectively is disposed at the beginning and end of the filling section to determine the density of the refrigerant, and wherein a control system is associated with the device.

The problem of prior known devices is solved by a device with the technical features in claim 1. Accordingly, the adapter hose assembly is segmented by inserting several pairs of respectively separate temperature and pressure sensors that are included in a calculation correction by a centralized mass calculator. The parameters of mass measuring by the mass measuring system are further available to the mass calculator, so that control of the filling valve of the adapter is assumed by the mass calculator. The mass calculator can be configured with any desired number of temperature and pressure sensor pairs as well as with a mass measuring system and filling valve control system as an encapsulated unit and can thus solve the metrological/calculation task in a repeatable manner, regardless of the performance of a control system.

This allows the calculation of mass deviations in line sections while filling with the refrigerant R744. This technical solution can accommodate a different hose segmentation. Other sensing and control equipment can be connected to the device, which upon request can perform a density calculation from the R744 enthalpy diagram for a connected pressure and temperature sensor system. The device controls the adapter filling valve and takes into account the correction calculation and directly processes the results of the measurement by the mass measuring system. This means that all metrological requirements resulting from the specifics of filling a system with refrigerant R744, and takes into account various extension levels of the adapter hose assembly, which includes an interface with the control system via which the required process information is exchanged.

### BRIEF DESCRIPTION OF DRAWINGS

An embodiment of the invention is described in greater detail below with reference to the drawing. Wherein:

FIG. 1 shows the basic structure of a filling section for the refrigerant R744 (prior art)

FIG. 2 shows a modified filling section for the refrigerant R744 in which a temperature and pressure sensor is inserted at the beginning and end of the filling line (prior art)

FIG. 3 shows the basic structure of a device with refrigerant R744 according to the invention for filling

### DETAILED DESCRIPTION

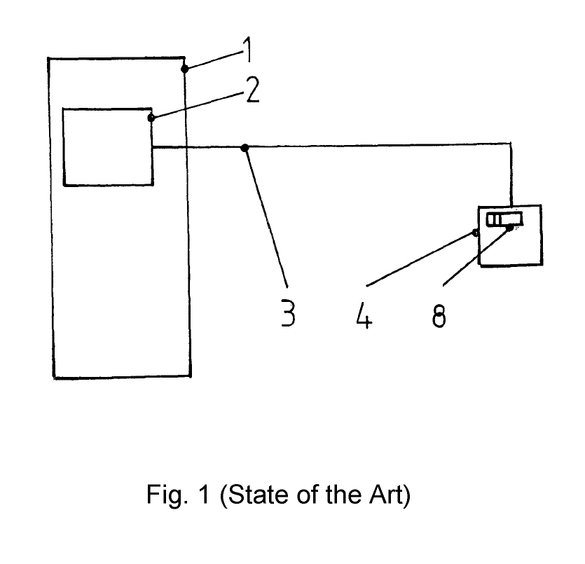

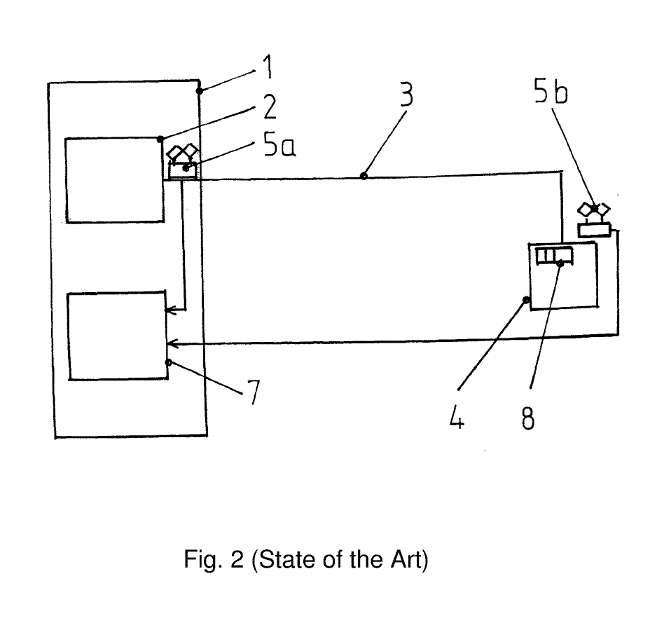

FIG. 1 and FIG. 2 show filling sections according to the state of the art described above, whose main assemblies include a hydraulic cabinet 1 with pumps, lines, and storage tank, a mass measuring system 2, an adapter hose assembly 3, an adapter 4 with filling valve 8, temperature and pressure sensors 5a or 5b, respectively, and a control system 7.

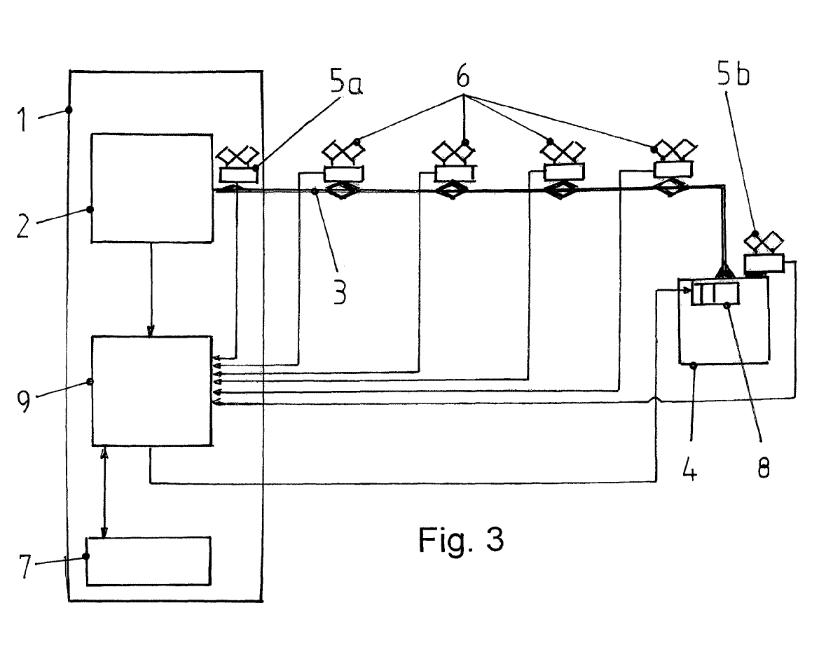

FIG. 3 shows filling section designed according to the invention for refrigerant R744. Likewise, a hydraulic cabinet 1 with pumps, lines, storage tank, a mass measuring system 2, an adapter hose assembly 3, and an adapter 4 with a filling valve 8 are provided as known from prior art. A temperature and pressure sensor 5a and 5b, respectively, is placed at the beginning and end of the adapter hose assembly 3; in addition, a control system 7 is associated with the device.

In the present context, it is essential that the adapter hose assembly 3 can have a segmented configuration and be split. This segmentation is designed based on functional aspects, preferably on aspects of handling. Respectively separate pairs of temperature and pressure sensors 6 are assigned to individual segments of the adapter hose assembly 3. These pairs of temperature and pressure sensors 6, whose number can be increased or decreased, allow calculation of density deviations in each line segment of the adapter hose assembly 3.

All measured data is captured and processed in real time by a mass calculator 9. Control of the filling valve 8, which depends on the correction calculation due to different density deviations and the mass measurement at the inlet of the section, is assumed by the mass calculator 9. An interface with the control system 7 allows handing over of process parameters such as the mass to be filled and handing over of results achieved.

### LIST OF REFERENCE SYMBOLS

1 Hydraulic cabinet/R744 filling system
2 Mass measuring system
3 Adapter hose assembly
4 Adapter
5a Temperature and pressure sensor at the beginning of the filling section
5b Temperature and pressure sensor at the end of the filling section
6 Pairs of temperature and pressure sensors at the segments of the filling section
7 Control system of the filling system
8 Filling valve
9 Mass calculator

1. A device for filling vehicle air conditioning systems with refrigerant R744, wherein the device comprises a filling system with pumps, lines, and storage tanks, an adapter hose assembly as the filling section, an adapter with a filling valve and a mass measuring system at the beginning of the filling section, wherein one temperature and pressure sensor respectively is disposed at the beginning and end of the filling section to determine the density of the refrigerant, and wherein a control system is associated with the device, wherein the adapter hose assembly is configured such that it is segmented, wherein segmentation takes place by inserting several pairs of respectively separate temperature and pressure sensors for determining the respective density of the refrigerant in the adapter hose assembly, wherein the device comprises a mass calculator for controlling the filling valve in accordance with a central correction calculation based on different density deviations determined using the pairs of respectively separate temperature and pressure sensors and also using the parameters of the mass measurement provided by the mass flow meter.
